(19) United States
(12) Patent Application Publication
(10) Pub. No.: US 2010/0251836 A1
(43) Pub. Date: Oct. 7, 2010

(54) Apparatus and method for obtaining asphalt paving samples

(76) Inventor: L. Trent Hunt, Twelve Mile, IN (US)

Correspondence Address: WENDELL E. MILLER, PATENT AGENT, 1506 TIPPECANOE DRIVE, D-1, WARSAW, IN, 46580, US

(21) Appl. No.: 12/384,176

(22) Filed: Apr. 1, 2009

(51) Int. Cl. G01N 1/04

(52) U.S. Cl. 73/864

(57) ABSTRACT

Asphalt-sampling apparatus (10) comprises a sample tray (12); a pair of spaced-apart holes (14) that are proximal to each of respective sides (16) of the sample tray (12); a pair of handles (20), comprising a pair of cable-portions (22), that are looped through respective pairs of the holes (14); a pair of snaps (28), that each include a swivel (30), that are snapped onto respective ones of the handles (20); a pair of lifting cables (26) that are attached to respective ones of the snaps (28); a locating cable (32) that is attached to both of the lifting cables (26); and a plurality of swivels (34) that are interspersed into the locating cable (32).

### CROSS-REFERENCES TO RELATED APPLICATIONS

Not Applicable

### STATEMENT RE FEDERALLY SPONSORED RESEARCH OR DEVELOPMENT

Not Applicable

### REFERENCE TO “SEQUENCE LISTING”

Not Applicable

### BACKGROUND OF THE INVENTION

1. Field of the Invention

The present invention relates generally to obtaining asphalt paving samples. More particularly, the present invention pertains to apparatus and method for expeditiously obtaining samples of paving asphalt while paving operations are suspended.

2. Description of the Related Art

In the United States, 94 percent of the 2.3 million miles of roads are paved with asphalt. And the 3,350 lane miles that are paved each year consume approximately 75.8 million tons of asphalt. Therefore, understanding that the cost of paving in the United States is a large portion of the budget of states, and that it consumes considerable federal funds, too, there is a need for quality-control over asphalt that is laid.

At the present time, twelve states have sampling and testing specifications for paving asphalt. And it is certain that more will follow shortly since, especially now with a downturn in the economy, nearly every state is faced with a serious shortfall in revenue, so care must be taken to assure that asphalt paving is according to specifications.

However, adding sample and test requirements onto the asphalt paving industry also means that the paving industry must absorb, or pass on to the city, county, or state, the costs of taking samples.

Of the twelve states that now have asphalt pavement sampling requirements, all specify that a layer of asphalt pavement be deposited on a small sample plate by the paving machine, that the sample plate be located under the resultant mass of hot asphalt by pulling on a wire that is attached to the plate, that the sample plate with a sample of hot asphalt thereon be lifted by sliding a pitchfork under the plate, that the sample plate with the asphalt sample be carried on the tines to a sample box, and that the sample be deposited in the sample box.

The process continues until four samples, two on larger plates, and two on smaller plates, or more, are taken. In the meantime, the paving machine and the entire paving crew, perhaps ten people, are idled, so taking asphalt paving samples is a costly process. However, often the loss of time and the resultant expense are much greater.

Sliding a pitchfork under a mass of hot asphalt to lift a plate with a sample of hot asphalt, carrying the plate and the asphalt sample to a sample box on the tines of a pitchfork, and depositing the asphalt sample in a box is more luck than skill. It is impossible to precisely position a pitchfork under a sample plate that is covered and surrounded by a layer of hot asphalt that is one to six inches thick.

If, as all too often happens, one sample plate with its asphalt sample slides off the pitchfork, the process must be repeated, since all samples must be taken from asphalt that has been laid at the same time.

Then, while an expensive asphalt spreading machine spreads asphalt over more sample plates, and while the new samples are found and safely deposited in boxes, production is shut down. The paving machine and the entire crew are idled because of an inefficient sampling apparatus and method.

### BRIEF SUMMARY OF THE INVENTION

In a preferred embodiment of the present invention, asphalt-sampling apparatus includes a sample plate, or sample tray, that preferably is cut from aluminum sheet, and that includes a pair of spaced-apart holes on each of two sides of the sample tray. A pair of bail handles are pivotally attached to the two sides of the sample tray by two eyes of each bail handle that curl through respective holes in the plate. Thus, the bail handles will pivot outward and downward, horizontally with respect to the plate, and will fold upward, extending substantially vertically through the sample of asphalt.

In the preferred embodiment of the present invention, the asphalt-sampling apparatus further includes a pair of lifting cables that are preferably stainless steel and that are each attached to respective ones of the handles by snaps and swivels, a locating cable that is attached to both of the locating cables and that includes swivels interposed at intervals, and a reel for winding, storing, and carrying the lifting cables and the locating cable.

The method of the present invention comprises at least some of the following steps, although all are not necessarily performed in the order recited: disposing a sample tray onto an asphalt-receiving surface; folding the handles of the sample tray outward onto the asphalt-receiving surface; snapping a lifting cable onto each of the handles; extending the lifting cables outward from the sample tray; attaching a locating cable to both of the lifting cables; depositing a layer of asphalt paving onto the sample tray and a surrounding area; pulling upwardly on the locating cables, pulling upwardly on the lifting cables; pulling the handles up through the layer of asphalt, grasping both of the handles; lifting the sample tray with an asphalt sample thereon; carrying the sample tray and the asphalt sample to a box; and depositing the asphalt sample in the box.

A first object of the present invention is to provide apparatus and method for taking asphalt samples in which failure to successfully lift, carry, and deposit the samples safely is minimized.

A second object of the present invention is to provide apparatus and method for taking asphalt samples in which the time required to obtain samples is minimized.

A third object of the present invention is to provide apparatus and method in which a sample tray is easily and accurately located beneath the asphalt.

A fourth object of the present invention is to provide apparatus and method in which a sample tray can be lifted safely and securely by placing separate lifting forces proximal to respective ends of the sample tray.

A fifth object of the present invention is to provide apparatus and method in which danger of dropping asphalt samples is minimized.

A sixth object of the present invention is to provide apparatus in which a sample tray includes handles.

A seventh object of the present invention is to provide apparatus in which a sample tray includes handles that fold outward and downward for receiving samples, and that fold upward for lifting and carrying.

An eighth object of the present invention is to provide apparatus in which the sample tray includes handles that fold outward and downward for receiving a sample of asphalt paving, and in which the handles are pivoted upward through the asphalt by cables that are attached to the handles, so that a portion of the handles extend upward through the deposited asphalt for ease and security of lifting the asphalt sample.

In a first aspect of the present invention, a method for obtaining asphalt paving samples comprises: disposing a sample tray onto an asphalt depositing surface; depositing a layer of paving asphalt onto the tray and onto the depositing surface peripherally around the sample tray; locating the tray beneath said layer of paving asphalt; lifting the tray with a sample of the layer thereon; and the lifting step comprises applying separate upward forces to opposite sides of the tray.

In a second aspect of the present invention, a method for obtaining asphalt paving samples comprises: attaching a pair of handles to a sample tray; placing the sample tray on a depositing surface; depositing a layer of paving asphalt on the sample tray, on the handles, and on the depositing surface peripherally around the sample tray and the handles; and lifting the sample tray with a sample thereon upward through the layer of asphalt.

In a third aspect of the invention, asphalt-sampling apparatus comprises: a sample tray; first and second handles attached to the tray; first and second lifting members attached to respective ones of the handles; and a locating member attached to both of the lifting members.

### BRIEF DESCRIPTION OF THE SEVERAL VIEWS OF THE DRAWINGS

FIG. 1 is a perspective view of the preferred embodiment of the present invention, showing the sample tray with bail handles, lifting cables, snaps, a locating cable, swivels, and reel;

FIG. 2 is a sectioned front elevation showing a portion of the sample tray, one of the bail handles, one of the snaps with its integral swivel, and a portion of one lifting cable, all under a layer of paving asphalt;

FIG. 3 is a sectioned front elevation, taken substantially the same as FIG. 2, showing a portion of one of the bail handles lifted through the asphalt of FIG. 2 by the lifting cable; and

FIG. 4 is a perspective view of a non-preferred embodiment of the present invention in which a sample basket is made of welded wire, and a sample tray is nested inside a frame of the sample basket.

### DETAILED DESCRIPTION OF THE INVENTION

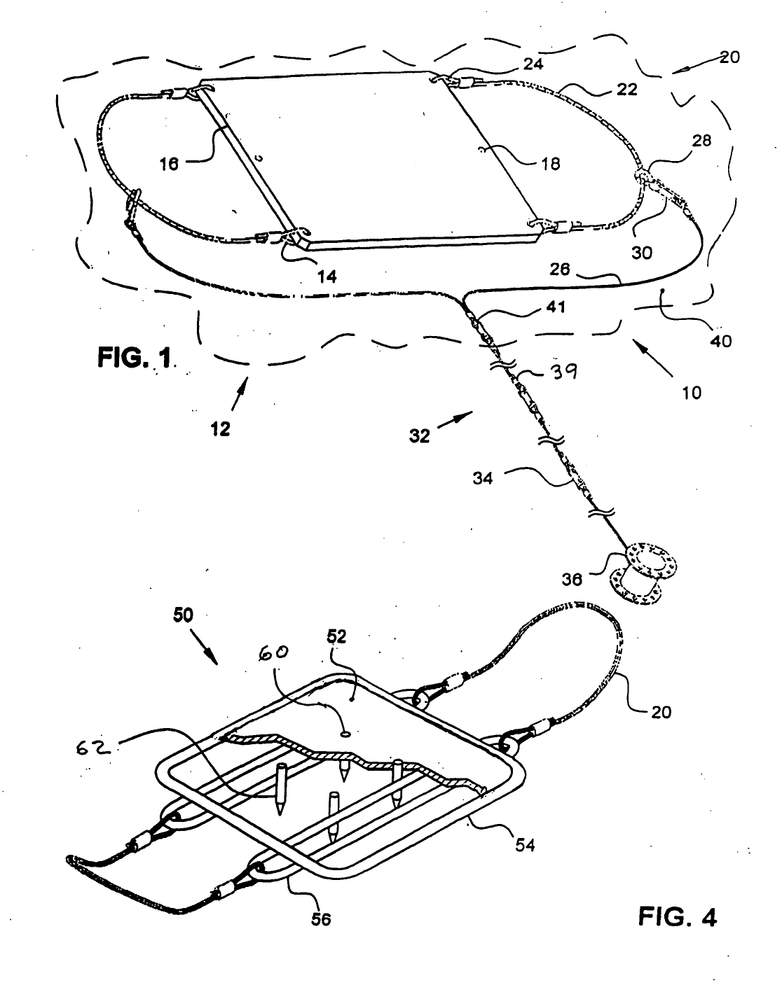

Referring now to FIG. 1, apparatus 10, for obtaining asphalt paving samples, comprises a sample tray 12 with a pair of spaced-apart holes 14 proximal to each of a pair of sides 16 of the sample tray 12. Another pair of holes 18, that are interposed intermediate respective ones of the holes 14 and proximal to respective sides 16, that may be used for nailing the sample tray 12 to existing asphalt before spreading asphalt over the sample tray 12.

The apparatus 10 further comprises a pair of bail handles, foldable handles, or pivotal handles 20 that each comprise a cable-portion 22 with ends 24 that loop through respective ones of the holes 14, a pair of first flexible tension members, lifting members, or lifting cables 26 that are each attached to respective ones of the handles 20 by snaps 28 with integral swivels 30, a third flexible tension member, locating member, or locating cable 32 that is attached to both of the lifting cables 26, a plurality of swivels 34 that are interspersed into the locating cable 32 at spaced-apart intervals, and a reel 36 that is attached to the locating cable 32, and that provides means for storing and carrying the cables, 26 and 32.

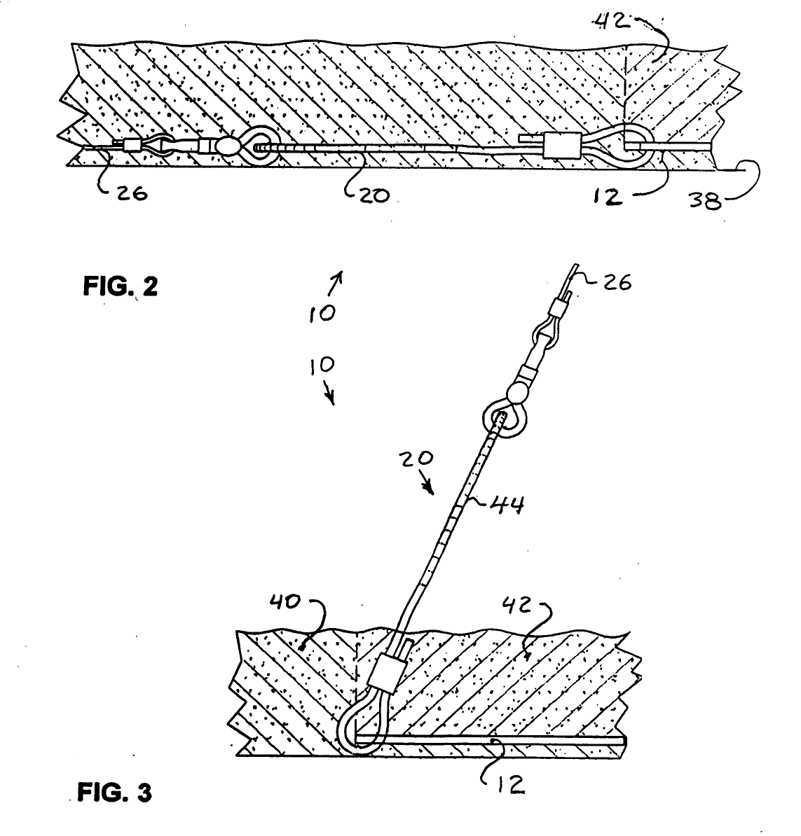

Referring now to FIG. 2, the sample tray 12 of the apparatus 10 is deposited onto an asphalt depositing surface 38 with the handles 20 (one shown) pivoted outward and downward onto the depositing surface 38, and with the lifting cables 26 (one shown) also lying on the depositing surface 38.

As shown in FIG. 1, the locating cable 32 is also lying on the depositing surface 38, and includes a portion 39 that extends outward from a deposited layer 40 of asphalt. Also as shown in FIG. 1, the deposited layer 40 extends peripherally around the sample tray 12 and an asphalt sample 42 of FIG. 2, so the sample tray 12 is disposed under the deposited layer 40 at a location that is not precisely known.

Referring now to FIG. 3, handles 20 (one shown) of the apparatus 10 have been pivoted upward from the sample tray 12 by lifting cables 26 (one shown), so that a portion 44 of each handle 20 extends upward though the deposited layer 40 for lifting a sample 42.

Referring now to FIG. 4, alternately, the sample tray 12 of FIGS. 1-3 may be replaced by a sample basket 50 and a sample tray 52. The sample basket 50 is made of welded wire and includes both a frame 54 and longitudinal support-loop members 56. The handles 20 of FIGS. 1-3, or any other suitable handles, may be attached to the support-loop members 56, as shown.

The sample tray 52 is nested inside the frame 54 and securely located by stud-nails 58 that are welded to the support-loop members 56, and that extend upward into holes 60 in the sample tray 52. The stud-nails 58 each include a nail portion 62 that extends downward, and that may be driven into the asphalt-depositing surface 38 of FIG. 2 to securely locate the sample basket 50. The sample tray 52 may be made of any suitable material, metallic or nonmetallic, and be disposable or nondisposable.

The method of the present invention comprises: disposing a sample tray 12 onto an asphalt depositing surface 38 of FIG. 2 with bail handles 20 pivoted outward and downward, one shown in FIG. 2, with lifting cables 26, one shown in FIG. 2, pivoted outward and downward on the asphalt depositing surface 38, and with a locating cable 32 extending outward on the asphalt depositing surface 38.

The method of the present invention further comprises: depositing a layer 40 of paving asphalt onto the sample tray 12 and onto the depositing surface 38 peripherally around the sample tray 1 2 with a portion 39 of the locating cable 32 extending outward from the deposited layer 40; locating the tray 12 beneath the deposited layer 40 of paving asphalt; lifting the tray 12 with a sample 42 of the deposited layer 40 thereon; and the lifting step comprises applying separate upward forces to opposite sides 16 of the tray 12.

The locating, lifting, and or applying steps of the present invention comprise one or more of the following steps: disposing a handle 20 in a lifting relationship with the sample tray 12 prior to the depositing step, and lifting a portion 44 of the handle 20 upwardly through the deposited layer 40; attaching a handle 20 to each of sides 16 of the sample tray 12 prior to the depositing step, and lifting a portion 44 of the handle 20 out of the deposited layer 40; attaching first and second cable-portions 22 to the sample tray 12 prior to the depositing step, and looping first and second ends 24 of each of the cable-portions 22 through respective holes 14 in the sample tray 12.

The locating, applying and/or lifting steps of the present invention optionally comprise: attaching a lifting cable 26 to the handle 20 prior to the depositing step; pulling the lifting cable 26 upward through the deposited layer 40; lifting a portion 44 of the handle 20 upward through the deposited layer 40; snap 28 attaching the lifting cable 26 to the handle prior 20 to the depositing step; snap 28 and swivel 30 attaching the lifting cable to the handle 20; attaching first and second handles 20 to opposite sides 16 of the sample tray 12 prior to the depositing step; disposing the first and second handles 20 horizontally outward with respect to the tray 12 prior to the depositing step; pivoting the handles 20 upwardly through the layer 40 of asphalt subsequent to the depositing step; attaching a lifting cable 26 to one of the handles 20 prior to the depositing step; and pulling on the lifting cable 26.

Alternately, the method of the present invention comprises: attaching a pair of handles 20 to a sample tray 12; placing the sample tray 12 on a depositing surface 38 with the handles 20 pivoted outward; depositing a layer 40 of paving asphalt on a sample tray 12, on the handles 20, and on the depositing surface 38 peripherally around the sample tray 12 and the handles 20; and lifting the handles 20 upward through the layer 40 of asphalt.

Optionally, the attaching and/or lifting steps comprise one or more of the following steps: attaching a lifting cable 26 to one of the foldable handles 20 prior to the depositing step; attaching a locating cable 32 to the lifting cables 26; disposing a portion 39 of a locating cable 32 outward from an intended asphalt-depositing area prior to the depositing step; pulling on the locating cable 32; lifting a portion 44 of the handles 20 upward; and lifting a sample 44 of the deposited layer 40.

Preferably the tray 12 is cut from commercial aluminum sheet that is 0.125 inches (3.2 mm.) thick, the bail handles 20 are made of stainless steel cable that is 0.125 inches (3.2 mm.) in diameter, and both the lifting cables 26 and the locating cable 32 are of stainless steel cable that is 0.062 inches (1.6 mm) in diameter. Optionally, the handles 20 are bails formed from solid steel wire.

While specific apparatus and method have been disclosed in the preceding description, it should be understood that these specifics have been given for the purpose of disclosing the principles of the present invention, and that many variations thereof will become apparent to those who are versed in the art. Therefore, the scope of the present invention is to be determined by the appended claims.

What is claimed is:

1. A method for obtaining asphalt paving samples which comprises:
a) disposing a sample tray onto an asphalt depositing surface;
b) depositing a layer of paving asphalt onto said tray and onto said depositing surface peripherally around said sample tray;
c) locating said tray beneath said layer of paving asphalt;
d) lifting said tray with a sample of said layer thereon; and
e) said lifting step comprises applying separate upward forces to opposite sides of said tray.

2. A method as claimed in claim 1 in which said step of applying separate upward forces comprises disposing a handle in a lifting relationship with said sample tray prior to said depositing step.

3. A method as claimed in claim 1 in which said step of applying separate upward forces comprises:
a) disposing a handle in a lifting relationship with said tray; and
b) lifting a portion of a handle upward through said deposited layer.

4. A method as claimed in claim 1 in which said step of applying separate upward forces comprises:
a) disposing a handle in a lifting relationship with said sample tray prior to said depositing step;
b) connecting a lifting member to said handle; and
c) pulling on said lifting member and a portion of said handle upward through said deposited layer.

5. A method as claimed in claim 1 in which said step of applying separate upward forces comprises:
a) attaching a handle to each of opposite sides of said sample tray prior to said depositing step; and
b) lifting a portion of said handles partially out of said deposited layer.

6. A method as claimed in claim 1 in which said step of applying separate upward forces comprises:
a) attaching a handle to each of respective sides of said sample tray prior to said depositing step; and
b) said attaching step comprises looping first and second ends of first and second cable-portions through spaced-apart holes proximal to respective sides of said sample tray.

7. A method as claimed in claim 2 in which said locating step comprises attaching a locating member to said handle prior to said depositing step.

8. A method as claimed in claim 2 in which:
a) said locating step comprises series attaching a locating member to a lifting member, attaching said lifting member to said handle prior to said depositing step, and pulling on said locating and lifting members subsequent to said depositing step; and
b) said lifting and applying steps comprise pulling said lifting member and said handle upward through said layer of deposited layer.

9. A method as claimed in claim 8 in which said attaching step comprises snap attaching said lifting member to said handle prior to said depositing step.

10. A method as claimed in claim 8 in which said attaching step comprises snap and swivel attaching said lifting member to said handle prior to said depositing step.

11. A method as claimed in claim 1 in which said step of applying separate upward forces comprises:
a) attaching first and second handles to opposite sides of said sample tray prior to said depositing step;
b) pivoting said first and second handles horizontally outward with respect to said tray prior to said depositing step; and
c) pivoting said handles upward through said layer of asphalt subsequent to said depositing step.

12. A method as claimed in claim 11 in which:
a) said locating step comprises pulling on a locating member; and
b) said lifting step comprises pulling on a lifting member.

13. A method for obtaining asphalt paving samples which comprises:
a) attaching a pair of handles to a sample tray;
b) placing said sample tray on a depositing surface;
c) depositing a layer of paving asphalt on said sample tray, on said handles, and on said depositing surface peripherally around said sample tray and said handles; and
d) lifting said sample tray with a sample thereon upward through said layer of asphalt.

14. A method as claimed in claim 13 in which said lifting step comprises attaching a lifting member to one of said handles prior to said depositing step.

15. A method as claimed in claim 13 in which said lifting step comprises:
a) attaching a locating member to a lifting member, and attaching said lifting member to one of said handles prior to said depositing step;
b) disposing a portion of said locating member outward from an asphalt depositing area prior to said depositing step; and
c) pulling said locating member, said lifting member, and said handle upward through said deposited layer.

16. A method as claimed in claim 13 in which:
a) said attaching of said handles comprises pivotally connecting first and second ends of a pair of cable portions through respective holes in said sample tray;
b) attaching a locating member to a lifting member, and attaching said lifting member to said to one of said handles prior to said depositing step;
c) said attaching of said lifting member to said handle comprises snap and swivel attaching;
d) disposing a portion of said locating member outwardly from an asphalt depositing area prior to said depositing step; and
e) pulling said locating member, said lifting member, and said handle upward through said deposited layer.

17. Asphalt-sampling apparatus which comprises:
a sample tray;
first and second handles attached to said tray;
first and second lifting members attached to respective ones of said handles; and
a locating member attached to both of said lifting members.

18. Asphalt-sampling apparatus as claimed in claim 17 in which attached handles comprise pivotally attached handles.

19. Asphalt-sampling apparatus as claimed in claim 17 in which:
said sample tray comprises first and second sides and a pair of spaced-apart holes proximal to respective ones of said sides; and
said handles and said attachment thereof comprise first and second bails with ends looped through respective pairs of said holes.

20. Asphalt-sampling apparatus as claimed in claim 17 in which:
said sample tray comprises first and second sides and a pair of spaced-apart holes proximal to respective ones of said sides;
said handles and said attachment thereof comprise first and second cable portions with ends looped through respective pairs of said holes;
said locating member comprises a flexible tension member;
said lifting member comprises a pair of flexible tension members;
said attachment of said lifting members to said tray comprise snaps and swivels; and
said apparatus further comprises a swivel interposed into said locating cable.
